(19) United States
(12) Patent Application Publication
(10) Pub. No.: US 2026/0330917 A1
(43) Pub. Date: Oct. 22, 2026

(54) CASINO-RELATED EMPLOYMENT IN THE METAVERSE

(71) Applicant: IGT, Las Vegas, NV (US)

(72) Inventors: Todd Grimm, Riverview (CA); Karen Van Niekerk, Dieppe (CA); Bethany Plimmer, Lower Coverdale (CA); Michael Russ, Graz (AT)

(21) Appl. No.: 19/184,273

(22) Filed: Apr. 21, 2025

(51) Int. Cl. G07F 17/32

(52) U.S. Cl. CPC G07F 17/3225

(57) ABSTRACT

Embodiments of the present disclosure are directed to operating a virtual casino and providing users an ability to function as employees within the virtual casino. According to one embodiment, a method for operating a virtual casino can comprise providing, to a plurality of user devices, a representation of the virtual casino, presenting a representation of a player of an electronic game in the virtual casino, and presenting. The employee of the virtual casino can comprise a three-dimensional, virtual character and the three-dimensional, virtual character can be associated with an electronic record comprising a field storing a value. The value stored in the field of the electronic record can be updated based on activity performed by the three-dimensional, virtual character in the virtual casino.

### BACKGROUND

The present disclosure is generally directed to virtual reality and more particularly to operating a virtual casino.

Virtual reality systems allow remote users to interact with a virtual reality environment. One example of a virtual reality environment is a virtual casinos through which players can experience the atmosphere of a casino remotely. In a virtual reality environment, players, other users, and automated bots can be represented by avatars. For example, users can, through their avatars, play casino-like games, interact with other players, and/or engage in social activities such as attending virtual concerts or events.

### BRIEF SUMMARY

Embodiments of the present disclosure are directed to operating a virtual casino and providing users an ability to function as employees within the virtual casino. According to one embodiment, a method for operating a virtual casino can comprise providing, to a plurality of user devices, a representation of the virtual casino, presenting a representation of a player of an electronic game in the virtual casino, and presenting. The employee of the virtual casino can comprise a three-dimensional, virtual character and the three-dimensional, virtual character can be associated with an electronic record comprising a field storing a value. The value stored in the field of the electronic record can be updated based on activity performed by the three-dimensional, virtual character in the virtual casino.

In some cases, the three-dimensional, virtual character can be controlled by a user of the host system. The virtual casino can comprise, in some cases, a virtual representation of a physical casino and the user can be remote from a geographic location of the physical casino. For example, the user of the host system can comprise a trainee of the physical casino. In other cases, the three-dimensional, virtual character can be controlled by Artificial Intelligence (AI).

Additionally, or alternatively, the activity in the virtual casino can be tracked. In some cases, a role of the three-dimensional, virtual character in the virtual casino can be updated based on the tracking of the activity in the virtual casino. In such cases, updating the value stored in the field of the electronic record based on activity performed by the three-dimensional, virtual character in the virtual casino can comprise updating the value by an amount based on the role of the three-dimensional, virtual character in the virtual casino. Additionally, or alternatively, permissions of the three-dimensional, virtual character in the virtual casino can be updated based on the tracking of the activity in the virtual casino. In some cases, tracking the activity in the virtual casino can comprise receiving feedback on the activity in the virtual casino from the player of the electronic game in the virtual casino.

According to another embodiment, a system can comprise a processor and a memory coupled with and readable by the processor, the memory can store therein a set of instructions which, when executed by the processor, can cause the processor to provide to a plurality of user devices, a representation of the virtual casino, present a representation of a player of an electronic game in the virtual casino, and present a representation of an employee of the virtual casino. The employee of the virtual casino can comprise a three-dimensional, virtual character and the three-dimensional, virtual character can be associated with an electronic record comprising a field storing a value. The instructions can further cause the processor to update the value stored in the field of the electronic record based on activity performed by the three-dimensional, virtual character in the virtual casino.

In some cases, the value stored in the field of the record can represent a value of a virtual currency. The virtual currency can be exchangeable for a real currency, in some such cases. In other cases, the value stored in the field of the record can represent a non-monetary benefit.

In some cases, the three-dimensional, virtual character can be controlled by a user of the host system. The user can comprise one of a plurality of users. In such cases, control of the three-dimensional, virtual character can pass between the plurality of users based on a time of day. Additionally, or alternatively, control of the three-dimensional, virtual character can be based on a consensus of the plurality of users. In some cases, the three-dimensional, virtual character can be further controlled by Artificial Intelligence (AI). In such cases, control of the three-dimensional, virtual character can pass between the AI and the user based on the activity performed by the three-dimensional, virtual character in the virtual casino.

According to yet another embodiment, a non-transitory, computer-readable medium can comprise a set of instructions stored therein which, when executed by a processor, can cause the processor to provide to a plurality of user devices, a representation of the virtual casino, present a representation of a player of an electronic game in the virtual casino, present a representation of an employee of the virtual casino, wherein the employee of the virtual casino comprises a three-dimensional, virtual character and wherein the three-dimensional, virtual character is associated with an electronic record comprising a field storing a value, and update the value stored in the field of the electronic record based on activity performed by the three-dimensional, virtual character in the virtual casino.

Additional features and advantages are described herein and will be apparent from the following Description and the figures.

### BRIEF DESCRIPTION OF THE SEVERAL VIEWS OF THE DRAWINGS

FIG. 1 is a diagram illustrating an exemplary environment in which embodiments of the present disclosure may be implemented.

FIG. 2 is a block diagram illustrating additional details of components of an exemplary virtual reality system according to one embodiment of the present disclosure.

FIG. 3 is a flowchart illustrating an exemplary process for operating a virtual casino according to one embodiment.

FIG. 4 is a flowchart illustrating an exemplary process for operating a virtual casino according to one embodiment.

FIG. 5 is a flowchart illustrating an exemplary process for operating a virtual casino according to one embodiment.

FIG. 6 is a flowchart illustrating an exemplary process for operating a virtual casino according to one embodiment.

### DETAILED DESCRIPTION

Embodiments of the present disclosure are directed to operating a virtual casino and providing users an ability to function as employees within the virtual casino. The metaverse is an ever-growing virtual world and as such it seems there are opportunities to monetize it in various ways. Embodiments are directed to introducing different employment opportunities within the metaverse, specifically related to the casino and gaming industry. Embodiments also introduce new opportunities such as leveraging the metaverse community to take over certain related tasks, as well as incentivization opportunities.

While not yet fully realizing its potential, the metaverse is, in essence, still a “world” where people interact. There are income-earning opportunities in this space, just like the real world. Game producers and casino operators can benefit from utilizing this space to introduce casino and gaming-related products. As a result of this, there is a need for people to have employment opportunities to handle similar roles that exist in the real world. These roles can be monetized, and as such enable game producers and casino operators to profit as well.

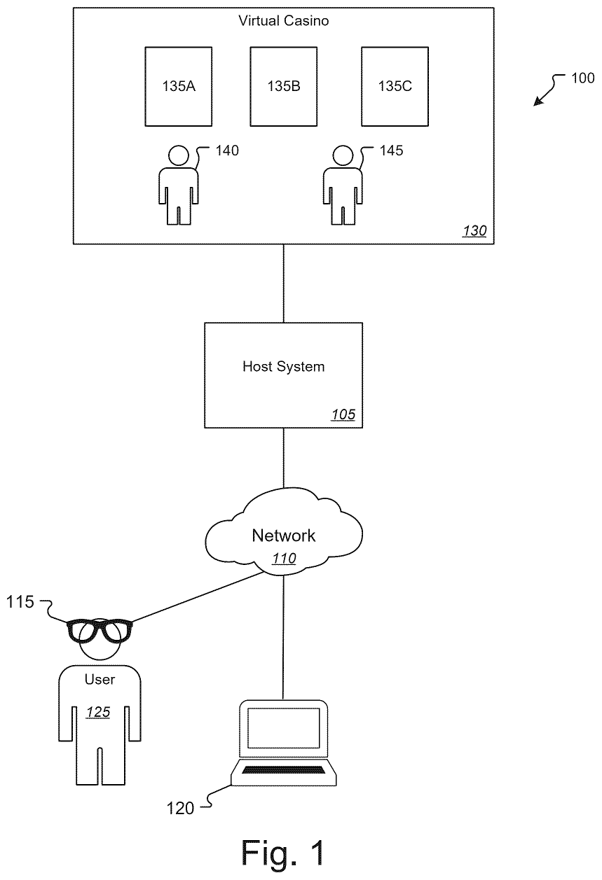

FIG. 1 is a diagram illustrating an exemplary environment in which embodiments of the present disclosure may be implemented. As illustrated in this example, the environment 100 can include a host system 105 communicatively coupled with a communications network 110. The communications network 110 can comprise any one or more wired and/or wireless local area and/or wide area networks as known in the art including, but not limited to, the Internet. Also coupled with the communications network 110 can be any number of VR user devices 115 and 120 such a wearable headset, glasses, etc., a mobile device such as a smartphone, tablet, personal computer, etc. as known in the art.

Through the VR devices 115 and 120, the host system 105 can provide to a user 125 a representation of a virtual casino 130. The virtual casino 130 can comprise one or more virtual Electronic Gaming Machines (EGMs) or other virtual gaming systems 135A-135C. Through one of the VR devices 115 or 120, a player can access and play one or more of the virtual games 135A-135C in the virtual casino 130. The players can be human, Artificial Intelligence (AI) controlled bots, or some combination thereof and can be represented in the virtual casino by an avatar 140.

According to one embodiment, an employee of the virtual casino 130, e.g., a dealer, a greeter, waitstaff, etc. The employee of the virtual casino 130 can be represented as a three-dimensional, virtual character 145. The three-dimensional, virtual character can be controlled by a human user 125 of the virtual reality system 105 who may be compensated in some way for performing as an employee.

In another case, the three-dimensional, virtual character may represent a person not employed by the casino but one of the other players, a regular visitor, a premium visitor, etc. who gets honored to do the job and deliver some hand pays or perform other task. In such cases, the person may receive some kind of compensation for the task. The compensation could be tied to money, or provide other benefits for that persons next real casino or virtual casino visit, etc. In some cases, three-dimensional, virtual characters or AI-generated bots can be aware of the metaverse player's player data, play preferences, and play history which could be used in some personalized hand pay, or events/scenes during the hand pay, for what the player would like to see. For example, the three-dimensional, virtual character 145 could be represented as a player's favorite celebrity who makes the hand-pay.

Functions and employee roles performed by an three-dimensional, virtual character are not limited to making hand pays. For example, the three-dimensional, virtual character can represent a greeter that greets players in the virtual casino 130 and provides assistance such as finding certain games in the virtual casino. In another case, the three-dimensional, virtual character can represent a play buddy for a player. In some cases, a user may start with a default virtual casino job and level up by collecting experience. For example, a default level could be a greeter. So, as user builds up experience, the user can be allowed to take the role or possession of three-dimensional, virtual characters with more complex responsibilities as trust is earned. In other cases, a user might choose to be different roles on different days.

According to one embodiment, different employee roles could have different compensation levels. For example, a user could enter the virtual casino and can be a greeter for X$ an hour or for Y$ an hour, but will be required to work more hours or have other requirements. In another example, the user could be a play buddy for Z$ an hour or could sign up for a tour and go through and tour all of the high performing games. According to one embodiment, the different employment roles could have different levels and people can sign up for what they want. However, the user might be required to fill out a virtual application form or provide information about themselves, e.g., to verify certain information about the user such as age verification, personal identification in the virtual casino, experience level, interpersonal skills, etc.

According to one embodiment, the virtual casino 130 could replicate a real-world, physical casino. In this way, users who are geographically remote from the location of that casino can still experience that casino. Additionally, embodiments provide the ability to work anywhere, anytime. Embodiments also give the user the opportunity to experience games that may not be available in the geographic region that user is located but without the need to travel.

Similarly, the ability for users to work remotely also gives casinos and companies the ability to hire remotely. In some cases, this can be for the purpose of training. For example, an employee may start in the virtual casino first. Then, the employer can decide, based on the user's skills, if they are going to hire that user to work in a real casino. Thus, the employer can train and evaluate the user in the virtual casino before deciding whether to invest in relocating that person, for example. According to one embodiment, expense-paid travel to the physical venue can also be one of the forms of compensation. If the user performs well as a dealer in the virtual casino for a period of time, the user can be given the opportunity to travel to the real-world casino and be a dealer there for a period of time.

Such training can comprise, a new user employee learning with premade scenarios in the virtual casino. The user can take a virtual course that is pre-designed to prove abilities. If the user performs correctly, the user can be presented the next situation, etc. until the course is finished. After that, the user can face a first live situation. If the user continues to perform, additional opportunities can be granted such as transitioning to a closest real-world location.

According to one embodiment, a user could be employed in the virtual casino as an assistant to player who is an influencer. For example, a user could be hired as a game buddy for the player, but the user helps to become the recorder for the player's influencer channel. In some cases, this can be an option offered to players who could sign up and have someone an employee video record the player and make a proper compilation for their social media. This option could be available to players on a pay or subscription basis.

As noted, rewards or compensation for users acting as employees in the virtual casino can be monetary of non-monetary. For example, the compensation can be a virtual currency usable only within the virtual casino or wider metaverse. In other cases, the virtual currency may be exchangeable for real currency, e.g., at a certain exchange rate for a real currency of the user's choice or location.

According to one embodiment, players in the virtual casino can provide feedback on the employees therein. For example, players in the virtual casino can be given an opportunity to rate their dealer or other hired employee. The rating can be used to evaluate the employee and may have an impact on the performance review, virtual salary, experience level, etc.

According to one embodiment, with experience, the user can increase not only the number of different jobs they are permitted to perform but can also be granted more permissions and/or more freedom to decide things. A user may start low permissions or without an ability to do certain things. However, as the user performs permitted tasks well and performs them better, the user can be granted more permissions with more different options for tasks they can perform. For example, an experienced user can be granted the ability to change the denomination of a machine or the minimum bet but a new user is not permitted to perform these tasks. In some cases, experience level and/or permissions granted can be related to compensation. This may be implemented as a “loyalty virtual casino employee” card/system tracking progresses made, similar to player's loyalty system.

According to one embodiment, and as noted above, a job performed by a three-dimensional, virtual character could start with an AI bot controlling all actions. Once a point is reached where the job is getting more complicated or requiring certain types of decisions, a real person user can be requested to take over. Similarly, a three-dimensional, virtual character can be controlled by a human user until the human user needs assistance. At such a point, an AI bot can take control of the three-dimensional, virtual character or provide assistance to the human user.

According to one embodiment, users can be scheduled to work certain shifts in the virtual casino with control of the three-dimensional, virtual character passing between the different users based on the schedule, time of day, and day of the week. In other cases, there may be more users interested in being employed for certain tasks than is possible to schedule. In such cases, decisions on actions to be taken by the three-dimensional, virtual character can be made conjointly with each user contributing their actions or their proposals. The majority decision by the users can become the final action that the three-dimensional, virtual character performs. In the case of a tie, the three-dimensional, virtual character can be split into two different instances with each instance performing a different action. Other tie-breaking options can be implemented. In any such case, if a decision is needed such as whether a player put their token on the number at the roulette table too late or early enough, if there are people voting to perform one action of the dealer, then it is not just one person's opinion, but the plurality of people's opinions it is more likely to be correct. In some cases, the ability to vote may need to be earned by a user, e.g., the user must reach a certain tier or experience level before being allowed to participate. Additionally, or alternatively, users can be allowed to bet on an action an three-dimensional, virtual character is going to take, i.e., based on a decision made by another user or AI. For example, there can be a certain number of slots or possibilities presented. When the slots are full for that three-dimensional, virtual character, a user wanting to participate may be placed on a wait list to get on as a decision maker.

According to one embodiment, an three-dimensional, virtual character can be a free-floating character that can do whatever it wants. In other cases, such as when a lot of decisions will be queueing up, users can decide how many decisions they want to contribute to. For example, one user may a period of time available to contribute to all the decisions within that time but then that user's shift will be over. Over time, the history of the decisions can be used to train employee models representing actions and decision for different employee roles and which can be used for AI control of the three-dimensional, virtual characters.

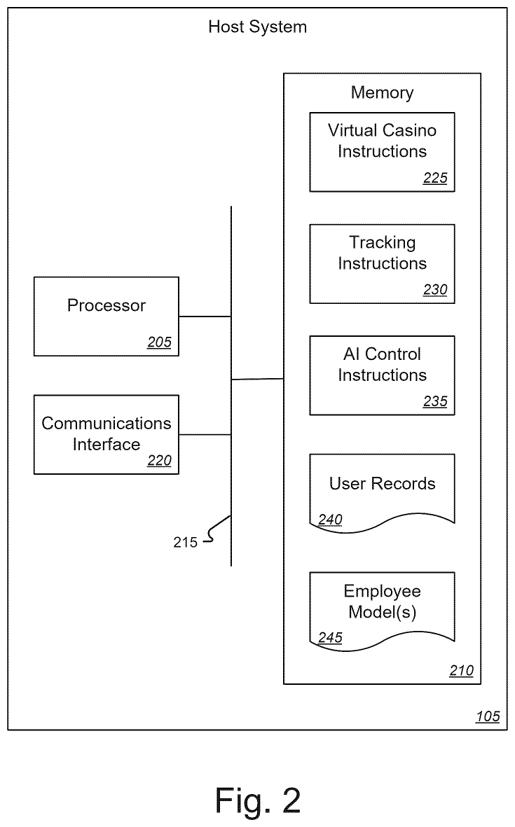

FIG. 2 is a block diagram illustrating additional details of components of an exemplary virtual reality system according to one embodiment of the present disclosure. As illustrated in this example, the host system 105 can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the host system 105 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communications interfaces 220. The communication interfaces 220 can comprise, for example, Ethernet, Bluetooth, WiFi, or other type of wired or wireless communications interfaces.

The memory 210 can store therein a set of virtual casino instructions 225 which, when executed by the processor 205, causes the processor 205 to provide, via the communications interface 220, to a plurality of user devices 115 and 120, a representation of the virtual casino 130. The virtual casino instructions 225 can cause the processor 205 to execute an electronic game within the virtual casino 130 and provide a representation of the electronic game, e.g., as a virtual EGM of other virtual gaming system 135A, to a user device 115 or 120. The virtual casino instructions 225 can further cause the processor 205 to present a representation of a player 140 of an electronic game in the virtual casino, and present a representation of an employee of the virtual casino. The employee of the virtual casino can comprise a three-dimensional, virtual character 145 and the three-dimensional, virtual character 145 can be associated with an electronic record 240 comprising a field storing a value. In some cases, the value stored in the field of the record 240 can represent a value of a virtual currency. The virtual currency can be exchangeable for a real currency, in some such cases. In other cases, the value stored in the field of the record 240 can represent a non-monetary benefit.

The memory 210 can further comprises a set of three-dimensional, virtual character tracking instructions 230 stored therein. The three-dimensional, virtual character tracking instructions, when executed by the processor 205, can further cause the processor 205 to track the activity 145 in the virtual casino 130 and update the value stored in the field of the electronic record based on activity performed by the three-dimensional, virtual character 145 in the virtual casino 130. In some cases, tracking the activity 145 in the virtual casino 130 can comprise receiving feedback on the activity 145 in the virtual casino 130 from the player of the electronic game in the virtual casino.

In some cases, the three-dimensional, virtual character tracking instructions 230 can further cause the processor 205 to update a role of the three-dimensional, virtual character 145 in the virtual casino 130. In such cases, updating the value stored in the field of the electronic record based on activity performed by the three-dimensional, virtual character 145 in the virtual casino 130 can comprise updating the value by an amount based on the role of the three-dimensional, virtual character 145 in the virtual casino 130. Additionally, or alternatively, the three-dimensional, virtual character tracking instructions 230 can further cause the processor 205 to update permissions of the three-dimensional, virtual character 145 in the virtual casino 130 based on the tracking of the activity 145 in the virtual casino 130.

In some cases, the three-dimensional, virtual character 145 can be controlled by a user 125 of the host system 105, i.e., based on messages and/or commands received through the communications interface 220. In some cases, the user can comprise one of a plurality of users. In such cases, the three-dimensional, virtual character tracking instructions 230 and/or virtual casino instructions 225 can further cause the processor 205 to pass control of the three-dimensional, virtual character between the plurality of users based on a time of day. Additionally, or alternatively, control of the three-dimensional, virtual character can be based on a consensus of the plurality of users. In such cases, the three-dimensional, virtual character tracking instructions 230 and/or virtual casino instructions 225 can further cause the processor 205 to determine the consensus of the users, e.g., based on input received via the communications interface 220, and control the three-dimensional, virtual character 145 based on the determined consensus.

The memory 210 can also have stored therein a set of three-dimensional, virtual character AI control instructions 235 which, when executed by the processor 205, can cause the processor 205 to control the three-dimensional, virtual character 145, e.g., based on one or more trained employee models 245 defining activities of employees within a casino. In such cases, the three-dimensional, virtual character AI control instructions 235 and or virtual casino instructions 225 can further cause the processor 205 to pass control of the three-dimensional, virtual character 145 between the AI and the user based on the activity being performed by the three-dimensional, virtual character 145 in the virtual casino 130 and/or other considerations as described above.

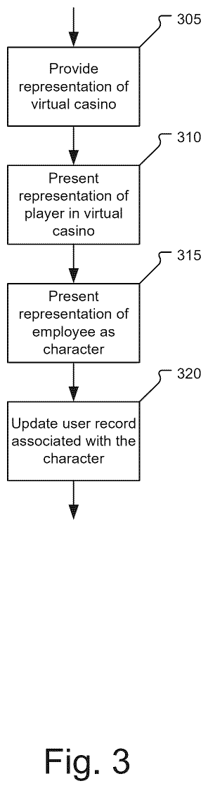

FIG. 3 is a flowchart illustrating an exemplary process for operating a virtual casino according to one embodiment. As illustrated in this example, operating a virtual casino can comprise providing 305, to a plurality of user devices 115 and 120, a representation of the virtual casino 130, presenting 310 a representation of a player 140 of an electronic game 135 in the virtual casino 130, and presenting 315 a representation of an employee of the virtual casino 130. The employee of the virtual casino can comprise a three-dimensional, virtual character 145. In some cases, the three-dimensional, virtual character 145 can be controlled by a user 125 of the host system 105. The virtual casino 130 can comprise, in some cases, a virtual representation of a physical casino and the user 125 can be remote from a geographic location of the physical casino. For example, the user 125 of the host system 105 can comprise a trainee of the physical casino. In other cases, the three-dimensional, virtual character 145 can be controlled in whole or in part by Artificial Intelligence (AI).

The three-dimensional, virtual character 145 can be associated with an electronic record 240 comprising a field storing a value. In some cases, the value stored in the field of the record can represent a value of a virtual currency. The virtual currency can be exchangeable for a real currency, in some such cases. In other cases, the value stored in the field of the record can represent a non-monetary benefit. The value stored in the field of the electronic record 240 can be updated 320 based on activity performed by the three-dimensional, virtual character 145 in the virtual casino 130.

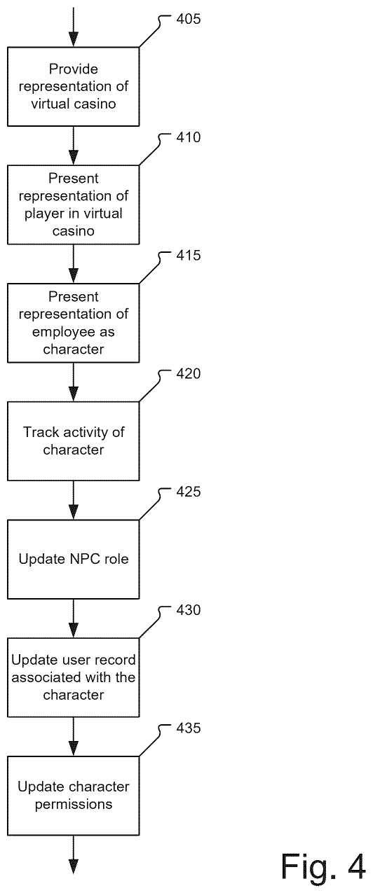

FIG. 4 is a flowchart illustrating an exemplary process for operating a virtual casino according to one embodiment. As illustrated in this example, operating a virtual casino can comprise providing 405, to a plurality of user devices 115 and 120, a representation of the virtual casino 130, presenting 410 a representation of a player 140 of an electronic game 135 in the virtual casino 130, and presenting 415 a representation of an employee of the virtual casino 130. The employee of the virtual casino can comprise a three-dimensional, virtual character 145. In some cases, the three-dimensional, virtual character 145 can be controlled by a user 125 of the host system 105. The virtual casino 130 can comprise, in some cases, a virtual representation of a physical casino and the user 125 can be remote from a geographic location of the physical casino. For example, the user 125 of the host system 105 can comprise a trainee of the physical casino. In other cases, the three-dimensional, virtual character 145 can be controlled in whole or in part by Artificial Intelligence (AI).

The three-dimensional, virtual character 145 can be associated with an electronic record 240 comprising a field storing a value. In some cases, the value stored in the field of the record can represent a value of a virtual currency. The virtual currency can be exchangeable for a real currency, in some such cases. In other cases, the value stored in the field of the record can represent a non-monetary benefit.

The activity 145 in the virtual casino 130 can be tracked 420. In some cases, tracking 420 the activity in the virtual casino can comprise receiving feedback on the activity in the virtual casino from the player of the electronic game in the virtual casino. In some cases, a role of the three-dimensional, virtual character in the virtual casino can be updated 425 based on the tracking of the activity in the virtual casino. The value stored in the field of the electronic record 240 can be updated 430 based on activity performed by the three-dimensional, virtual character 145 in the virtual casino 130. In some cases, updating 430 the value stored in the field of the electronic record 240 based on activity performed by the three-dimensional, virtual character 145 in the virtual casino 130 can comprise updating the value by an amount based on the role of the three-dimensional, virtual character 145 in the virtual casino 130. Additionally, or alternatively, permissions of the three-dimensional, virtual character 145 in the virtual casino 130 can be updated 435 based on the tracking 420 of the activity 145 in the virtual casino 130.

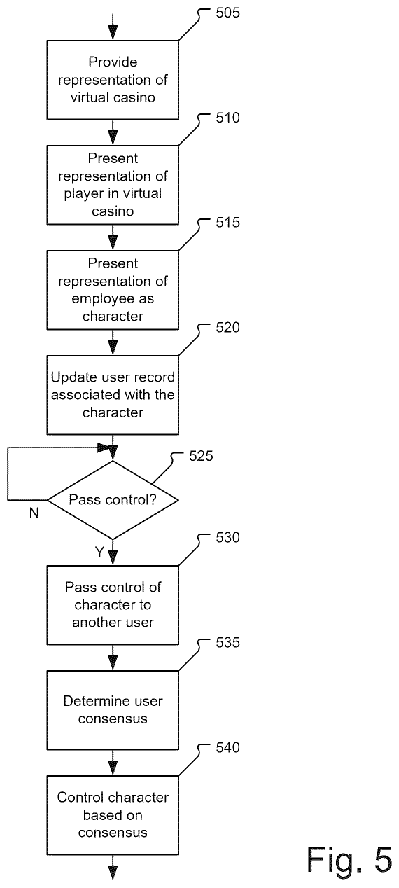

FIG. 5 is a flowchart illustrating an exemplary process for operating a virtual casino according to one embodiment. As illustrated in this example, operating a virtual casino can comprise providing 505, to a plurality of user devices 115 and 120, a representation of the virtual casino 130, presenting 510 a representation of a player 140 of an electronic game 135 in the virtual casino 130, and presenting 515 a representation of an employee of the virtual casino 130. The employee of the virtual casino can comprise a three-dimensional, virtual character 145. In some cases, the three-dimensional, virtual character 145 can be controlled by a user 125 of the host system 105. The virtual casino 130 can comprise, in some cases, a virtual representation of a physical casino and the user 125 can be remote from a geographic location of the physical casino. For example, the user 125 of the host system 105 can comprise a trainee of the physical casino. In other cases, the three-dimensional, virtual character 145 can be controlled in whole or in part by Artificial Intelligence (AI).

The three-dimensional, virtual character 145 can be associated with an electronic record 240 comprising a field storing a value. In some cases, the value stored in the field of the record can represent a value of a virtual currency. The virtual currency can be exchangeable for a real currency, in some such cases. In other cases, the value stored in the field of the record can represent a non-monetary benefit. The value stored in the field of the electronic record 240 can be updated 520 based on activity performed by the three-dimensional, virtual character 145 in the virtual casino 130.

In some cases, the three-dimensional, virtual character 145 can be controlled by a user 125 of the host system 105. The user 125 can comprise one of a plurality of users. In such cases, a determination 525 can be made as to whether control of the three-dimensional, virtual character 145 should pass to another user. This determination 525 can be made, for example, based on a time of day and a schedule for the user or on other factors as described above. In response to determining 525 to pass control of the three-dimensional, virtual character 145, control can be passed 530 to another user.

Additionally, or alternatively, control of the three-dimensional, virtual character 145 can be based on a consensus of the plurality of users. In such cases, the consensus of the users can be determined as described above and the three-dimensional, virtual character can be controlled 540 based on the determined consensus.

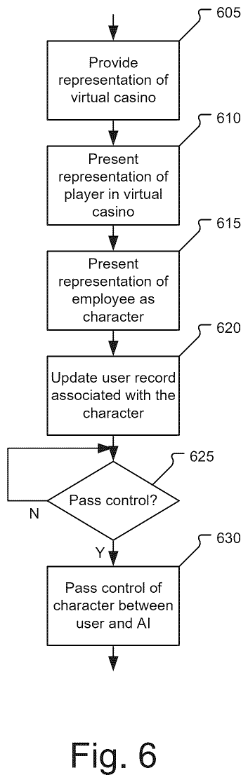

FIG. 6 is a flowchart illustrating an exemplary process for operating a virtual casino according to one embodiment. As illustrated in this example, operating a virtual casino can comprise providing 605, to a plurality of user devices 115 and 120, a representation of the virtual casino 130, presenting 610 a representation of a player 140 of an electronic game 135 in the virtual casino 130, and presenting 615 a representation of an employee of the virtual casino 130. The employee of the virtual casino can comprise a three-dimensional, virtual character 145. In some cases, the three-dimensional, virtual character 145 can be controlled by a user 125 of the host system 105. The virtual casino 130 can comprise, in some cases, a virtual representation of a physical casino and the user 125 can be remote from a geographic location of the physical casino. For example, the user 125 of the host system 105 can comprise a trainee of the physical casino. In other cases, the three-dimensional, virtual character 145 can be controlled in whole or in part by Artificial Intelligence (AI).

The three-dimensional, virtual character 145 can be associated with an electronic record 240 comprising a field storing a value. In some cases, the value stored in the field of the record can represent a value of a virtual currency. The virtual currency can be exchangeable for a real currency, in some such cases. In other cases, the value stored in the field of the record can represent a non-monetary benefit. The value stored in the field of the electronic record 240 can be updated 620 based on activity performed by the three-dimensional, virtual character 145 in the virtual casino 130.

In some cases, the three-dimensional, virtual character can be further controlled by Artificial Intelligence (AI). In such cases, a determination 625 can be made as to whether control of the three-dimensional, virtual character 145 should pass from the user to the AI or from the AI to the user, depending on which is currently in control. This determination 525 can be made, for example, based on the activity performed by the three-dimensional, virtual character 145 in the virtual casino 130. In response to determining 525 to pass control of the three-dimensional, virtual character 145, control of the three-dimensional, virtual character 145 can pass 530 between the AI and the user based on

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for operating a virtual casino, the method comprising:
providing, by a host system, to a plurality of user devices, a representation of the virtual casino;
presenting, by the host system, a representation of a player of an electronic game in the virtual casino;
presenting, by the host system, a representation of an employee of the virtual casino, wherein the employee of the virtual casino comprises a three-dimensional, virtual character and wherein the three-dimensional, virtual character is associated with an electronic record comprising a field storing a value; and
updating, by the host system, the value stored in the field of the electronic record based on activity performed by the three-dimensional, virtual character in the virtual casino.

2. The method of claim 1, wherein the three-dimensional, virtual character is controlled by a user of the host system.

3. The method of claim 1, wherein the virtual casino comprises a virtual representation of a physical casino and wherein the user is remote from a geographic location of the physical casino.

4. The method of claim 3, wherein the user of the host system comprises a trainee of the physical casino.

5. The method of claim 1, wherein the three-dimensional, virtual character is controlled by Artificial Intelligence (AI).

6. The method of claim 1, further comprising tracking, by the host system, the activity in the virtual casino.

7. The method of claim 6, further comprising updating, by the host system, a role of the three-dimensional, virtual character in the virtual casino based on the tracking of the activity in the virtual casino.

8. The method of claim 7, wherein updating the value stored in the field of the electronic record based on activity performed by the three-dimensional, virtual character in the virtual casino comprises updating the value by an amount based on the role of the three-dimensional, virtual character in the virtual casino.

9. The method of claim 6, further comprising updating, by the host system, permissions of the three-dimensional, virtual character in the virtual casino based on the tracking of the activity in the virtual casino.

10. The method of claim 6, wherein tracking the activity in the virtual casino comprises receiving feedback on the activity in the virtual casino from a plurality of players of the electronic game in the virtual casino.

11. A system comprising:
a processor; and
a memory coupled with and readable by the processor and storing therein a set of instructions which, when executed by the processor, causes the processor to:
provide to a plurality of user devices, a representation of the virtual casino;
present a representation of a player of an electronic game in the virtual casino;
present a representation of an employee of the virtual casino, wherein the employee of the virtual casino comprises a three-dimensional, virtual character and wherein the three-dimensional, virtual character is associated with an electronic record comprising a field storing a value; and
update the value stored in the field of the electronic record based on activity performed by the three-dimensional, virtual character in the virtual casino.

12. The system of claim 11, wherein the value stored in the field of the record represents a value of a virtual currency.

13. The system of claim 12, wherein the virtual currency is exchangeable for a real currency.

14. The system of claim 11, wherein the value stored in the field of the record represents a non-monetary benefit.

15. The system of claim 11, wherein the three-dimensional, virtual character is controlled by a user of the host system.

16. The system of claim 15, wherein the user comprises one of a plurality of users and wherein control of the three-dimensional, virtual character passes between the plurality of users based on a time of day.

17. The system of claim 15, wherein the user comprises one of a plurality of users and control of the three-dimensional, virtual character is based on a consensus of the plurality of users.

18. The system of claim 15, wherein the three-dimensional, virtual character is further controlled by Artificial Intelligence (AI).

19. The system of claim 18, wherein control of the three-dimensional, virtual character passes between the AI and the user based on the activity performed by the three-dimensional, virtual character in the virtual casino.

20. A non-transitory, computer-readable medium comprising a set of instructions stored therein which, when executed by a processor, causes the processor to:
provide to a plurality of user devices, a representation of the virtual casino;
present a representation of a player of an electronic game in the virtual casino;
present a representation of an employee of the virtual casino, wherein the employee of the virtual casino comprises a three-dimensional, virtual character and wherein the three-dimensional, virtual character is associated with an electronic record comprising a field storing a value; and
update the value stored in the field of the electronic record based on activity performed by the three-dimensional, virtual character in the virtual casino.
